(19) United States
(12) Patent Application Publication
(10) Pub. No.: US 2024/0086391 A1
(43) Pub. Date: Mar. 14, 2024

(54) INSPECTION AND REPAIR OF OBJECT METADATA IN VIRTUAL STORAGE AREA NETWORKS

(71) Applicant: VMware, Inc., Palo Alto, CA (US)

(72) Inventors: Kevin Rayfeng LI, Palo Alto, CA (US); Wenguang WANG, Santa Clara, CA (US); Quanxing LIU, Mountain View, CA (US); Pascal RENAULD, Palo Alto, CA (US); Kiran PATIL, Fremont, CA (US)

(73) Assignee: VMware, Inc., Palo Alto, CA (US)

(21) Appl. No.: 17/940,853

(22) Filed: Sep. 8, 2022

(51) Int. Cl. G06F 16/23; G06F 9/455

(52) U.S. Cl. CPC G06F 16/2365; G06F 9/45558; G06F 2009/45583

(57) ABSTRACT

Systems and methods for inspection and repair of VSAN object metadata. A user-space indirection layer is maintained to map logical addresses of VSAN objects to physical memory addresses of their metadata. Commands may then be sent from the user space to distributed object manager (DOM) clients, with the physical addresses of metadata of objects to be inspected. DOM owners thus may bypass their own indirection layers to retrieve object metadata directly from received user commands. Retrieved information is then used to reconstruct and repair object metadata. Repaired metadata may be written back to the VSAN by transmitting a write request containing the physical address at which the repaired metadata is to be written. DOM owners may be placed in a specified mode in which received I/O instructions are ignored unless they are designated as being for metadata repair purposes, such as by including a physical address.

### FIELD

The present disclosure relates generally to virtual storage area networks. More specifically, the present disclosure relates to inspection and repair of object metadata in virtual storage area networks.

### BACKGROUND

Contemporary distributed-computing systems often generate, and require storage for, significant amounts of data. Often, such storage is managed using virtual storage area networks (VSANs), which divide and allocate portions of physical storage area networks into one or more logical storage area networks, thus providing users virtual storage pools that can potentially store large quantities of data, for instance, among hosts in a cluster.

VSANs also can present significant challenges, however. VSANs may often store data in objects whose structures are defined by metadata. Corruption of this metadata threatens the integrity of stored data objects, and also risks undesirable events such as kernel crashes. Currently, VSAN metadata is typically repaired using conventional methods for inspecting and repairing file system metadata. These methods suffer from certain drawbacks when applied to VSAN metadata, though. For example, conventional file system metadata repair methods often fail when applied to more complex metadata structures employed by VSANs. Conventional repair methods also typically require an entire file system to be unmounted during repair, thus increasing system downtime. Accordingly, ongoing efforts exist to better prevent and/or repair corruption or other inaccuracies in VSAN object metadata.

### SUMMARY

In some embodiments of this disclosure, systems and methods are described for inspection and repair of VSAN object metadata. A user-space indirection layer is maintained to map logical addresses of VSAN objects to the physical memory addresses of their metadata. Commands may then be sent from the user space to distributed object manager (DOM) clients, with physical addresses of metadata of objects to be inspected. DOM owners thus have no need to look up a corresponding physical address from a logical address, and may bypass their own indirection layers to retrieve object data and metadata directly from received user space commands. Retrieved information is then used to reconstruct and, if necessary, repair the object metadata in the user space. Repaired metadata may then be written back to the VSAN by transmitting a write request containing the physical address at which the repaired metadata is to be written. In this manner, any VSAN metadata, regardless of complexity, may be inspected and repaired, as the physical locations of objects and their metadata are maintained in the application layer.

To implement repairs, DOM owners may be instructed to enter a specified state or mode in which any received read or write requests are ignored unless they are explicitly designated as being for metadata repair purposes, such as by including a physical address, a bypass flag setting, or in any other desired manner. This allows metadata repairs to be carried out as above, bypassing VSAN internal indirection layers. Accordingly, no other operations may potentially access, modify, or corrupt metadata while repairs are carried out, yet the storage system need not be unmounted.

In some embodiments of the disclosure, a method of inspecting metadata of virtual storage area network (VSAN) objects comprises transmitting, to a distributed object manager (DOM) client of the VSAN, a request to retrieve metadata of a DOM object, the request including a physical memory address of the metadata of the DOM object. The method also includes receiving, from the DOM client and responsive to the transmitted request, the retrieved metadata corresponding to the physical memory address, and determining, at least in part from the retrieved metadata corresponding to the physical memory address, a data structure of the metadata of the DOM object. The determined data structure may then be stored in a memory.

In some other embodiments of the disclosure, a non-transitory computer-readable storage medium is described. The computer-readable storage medium includes instructions configured to be executed by one or more processors of a computing device and to cause the computing device to carry out steps that include: transmitting, to a distributed object manager (DOM) client of the VSAN, a request to retrieve metadata of a DOM object, the request including a physical memory address of the metadata of the DOM object; receiving, from the DOM client and responsive to the transmitted request, the retrieved metadata corresponding to the physical memory address; determining, at least in part from the retrieved metadata corresponding to the physical memory address, a data structure of the metadata of the DOM object; and storing the determined data structure in a memory.

Other aspects and advantages of embodiments of the disclosure will become apparent from the following detailed description taken in conjunction with the accompanying drawings which illustrate, by way of example, the principles of the described embodiments.

### BRIEF DESCRIPTION OF THE DRAWINGS

The disclosure will be readily understood by the following detailed description in conjunction with the accompanying drawings, wherein like reference numerals designate like structural elements.

FIG. 1A is a block diagram illustrating a system and environment for implementing various components of a distributed-computing system, in accordance with some embodiments of the disclosure;

FIG. 1B is a block diagram illustrating a containerized application framework for implementing various components of a distributed-computing system, in accordance with some embodiments of the disclosure;

FIG. 2 is a block diagram illustrating a virtual storage area network (VSAN), in accordance with some embodiments of the disclosure;

FIG. 3A is a block diagram illustrating the structure of a data object that includes one or more data components, in accordance with some embodiments of the disclosure;

FIG. 3B is a block diagram illustrating a VSAN storing one or more data components in different storage nodes, in accordance with some embodiments of the disclosure;

FIG. 4 is a block diagram representation of a process for inspecting and repairing VSAN object metadata;

FIG. 5 is a block diagram representation of an exemplary process for inspecting and repairing VSAN object metadata, in accordance with some embodiments of the disclosure; and

FIG. 6 is a flowchart illustrating process steps for inspecting and repairing VSAN object metadata, in accordance with some embodiments of the disclosure.

### DETAILED DESCRIPTION

Certain details are set forth below to provide a sufficient understanding of various embodiments of the disclosure. However, it will be clear to one skilled in the art that embodiments of the disclosure may be practiced without one or more of these particular details, or with other details. Moreover, the particular embodiments of the present disclosure described herein are provided by way of example and should not be used to limit the scope of the disclosure to these particular embodiments. In other instances, hardware components, network architectures, and/or software operations have not been shown in detail in order to avoid unnecessarily obscuring the disclosure.

In some embodiments of this disclosure, systems and methods are described for inspection and repair of VSAN object metadata. A user-space indirection layer is maintained to map logical addresses of VSAN objects to the physical memory addresses of their metadata. Commands may then be sent from the user space to distributed object manager (DOM) clients, with the physical addresses of metadata of objects to be inspected. DOM owners thus have no need to look up a corresponding physical address from a logical address, and may bypass their own internal indirection layers to retrieve object data and metadata directly from received user space commands. Retrieved information is then used to reconstruct and, if necessary, repair the object metadata in the user space. Repaired metadata may then be written back to the VSAN by transmitting a write request containing the physical address at which the repaired metadata is to be written. In response to this request or to another command, DOM owners may enter a specified state in which any received read or write instructions are ignored unless they are explicitly designated as being for metadata repair purposes, such as by including a physical address or in any other desired manner. This allows metadata repairs to be carried out as above, bypassing VSAN indirection layers. Accordingly, no other operations may potentially access, modify, or corrupt metadata while repairs are carried out, yet the storage system need not be unmounted.

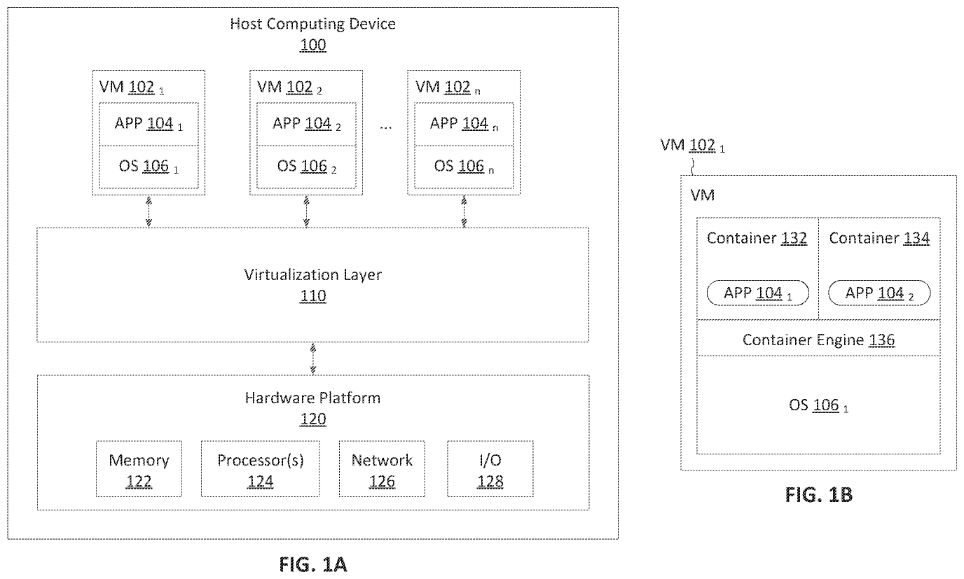

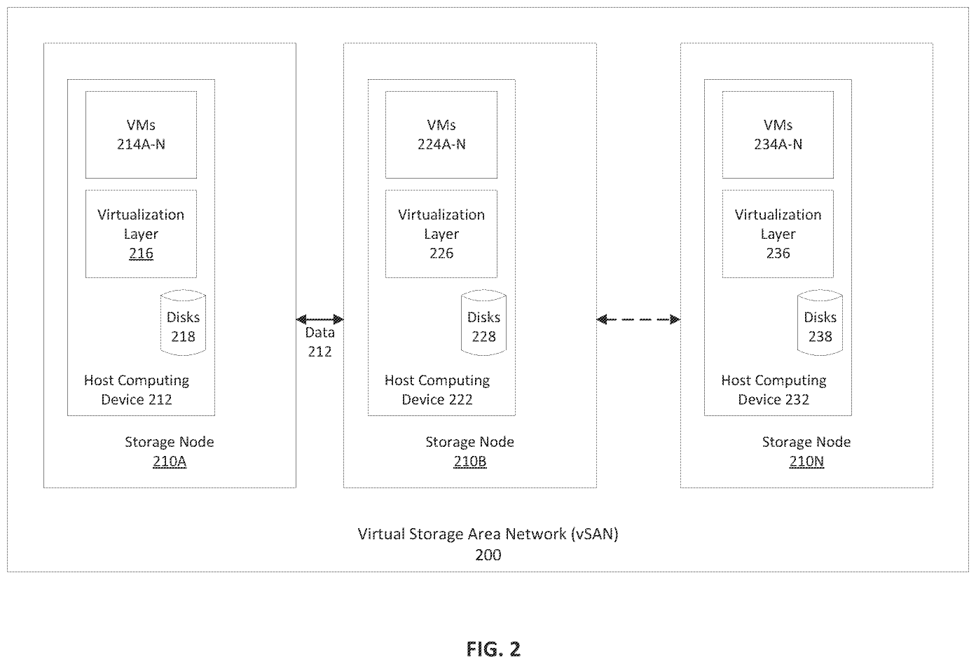

FIG. 1A is a block diagram illustrating a system and environment for implementing various components of a distributed-computing system, according to some embodiments of the disclosure. As shown in FIG. 1, virtual machines (VMs) 1021, 1022 . . . 120n are instantiated on host computing device 100. In some embodiments, host computing device 100 implements one or more elements of a distributed-computing system (e.g., storage nodes of a VSAN 200 described with reference to FIG. 2). Hardware platform 120 includes memory 122, one or more processors 124, network interface 126, and various I/O devices 128. Memory 122 includes one or more computer-readable storage media. The computer-readable storage media are, for example, tangible and non-transitory. For example, memory 122 includes high-speed random access memory and also includes non-volatile memory, such as one or more magnetic disk storage devices, flash memory devices, or other non-volatile solid-state memory devices. In some embodiments, the computer-readable storage media of memory 122 stores instructions for performing the methods and processes described herein. In some embodiments, hardware platform 120 also includes other components, including power supplies, internal communications links and busses, peripheral devices, controllers, and many other components.

Virtualization layer 110 is installed on top of hardware platform 120. Virtualization layer 110, also referred to as a hypervisor, is a software layer that provides an execution environment within which multiple VMs 102 are concurrently instantiated and executed. The execution environment of each VM 102 includes virtualized components analogous to those comprising hardware platform 120 (e.g. a virtualized processor(s), virtualized memory, etc.). In this manner, virtualization layer 110 abstracts VMs 102 from physical hardware while enabling VMs 102 to share the physical resources of hardware platform 120. As a result of this abstraction, each VM 102 operates as though it has its own dedicated computing resources.

Each VM 102 includes operating system (OS) 106, also referred to as a guest operating system, and one or more applications (e.g., apps) 104 running on or within OS 106. OS 106 (e.g., Darwin, RTXC, LINUX, UNIX, OS X, iOS, WINDOWS, or an embedded operating system such as VxWorks) includes various software components and/or drivers for controlling and managing general system tasks (e.g., memory management, storage device control, power management, etc.) and facilitates communication between various hardware and software components. As in a traditional computing environment, OS 106 provides the interface between apps 104 (i.e. programs containing software code) and the hardware resources used to execute or run applications. However, in this case the “hardware” is virtualized or emulated by virtualization layer 110. Consequently, apps 104 generally operate as though they are in a traditional computing environment. That is, from the perspective of apps 104, OS 106 appears to have access to dedicated hardware analogous to components of hardware platform 120.

FIG. 1B is a block diagram illustrating a containerized application framework for implementing various components of a distributed-computing system, in accordance with some embodiments. More specifically, FIG. 1B illustrates VM 1021 implementing a containerized application framework. Containerization provides an additional level of abstraction for applications by packaging a runtime environment with each individual application. Container 132 includes app 1041 (i.e., application code), as well as all the dependencies, libraries, binaries, and configuration files needed to run app 1041. Container engine 136, similar to virtualization layer 110 discussed above, abstracts app 1041 from OS 1061, while enabling other applications (e.g., app 1042) to share operating system resources (e.g., the operating system kernel). As a result of this abstraction, each app 104 executes in a same or similar manner regardless of the execution environment (e.g., as though it has its own dedicated operating system). In some embodiments, a container (e.g., container 132 or 134) can include a gateway application or process, as well as all the dependencies, libraries, binaries, and configuration files needed to run the gateway applications.

It should be appreciated that applications (apps) implementing aspects of the present disclosure are, in some embodiments, implemented as applications running within traditional computing environments (e.g., applications executed on an operating system with dedicated physical hardware), virtualized computing environments (e.g., applications executed on a guest operating system on virtualized hardware), containerized environments (e.g., applications packaged with dependencies and executed within their own runtime environment), distributed-computing environments (e.g., applications executed on or across multiple physical hosts) or any combination thereof. Furthermore, while specific implementations of virtualization and containerization are discussed, it should be recognized that other implementations of virtualization and containers can be used without departing from the scope of the various described embodiments.

FIG. 2 is a block diagram illustrating a virtual storage area network (VSAN) 200, in accordance with some embodiments. As described above, a VSAN is a logical partitioning of a physical storage area network. A VSAN divides and allocates a portion of or an entire physical storage area network into one or more logical storage area networks, thereby enabling the user to build a virtual storage pool. As illustrated in FIG. 2, VSAN 200 can include a cluster of storage nodes 210A-N, which can be an exemplary virtual storage pool. In some embodiments, each node of the cluster of storage nodes 210A-N can include a host computing device. FIG. 2 illustrates that storage node 210A includes a host computing device 212; storage node 210B includes a host computing device 222; and so forth. In some embodiments, the host computing devices (e.g., devices 212, 222, 232) can be implemented using host computing device 100 described above. For example, as shown in FIG. 2, similar to those described above, host computing device 212 operating in storage node 210A can include a virtualization layer 216 and one or more virtual machines 214A-N (collectively as VMs 214). In addition, host computing device 212 can also include one or more disks 218 (e.g., physical disks) or disk groups. In some embodiments, VM 214 can have access to one or more physical disks 218 or disk groups via virtualization layer 216 (e.g., a hypervisor). In the description of this application, a storage node is sometimes also referred to as a host computing device.

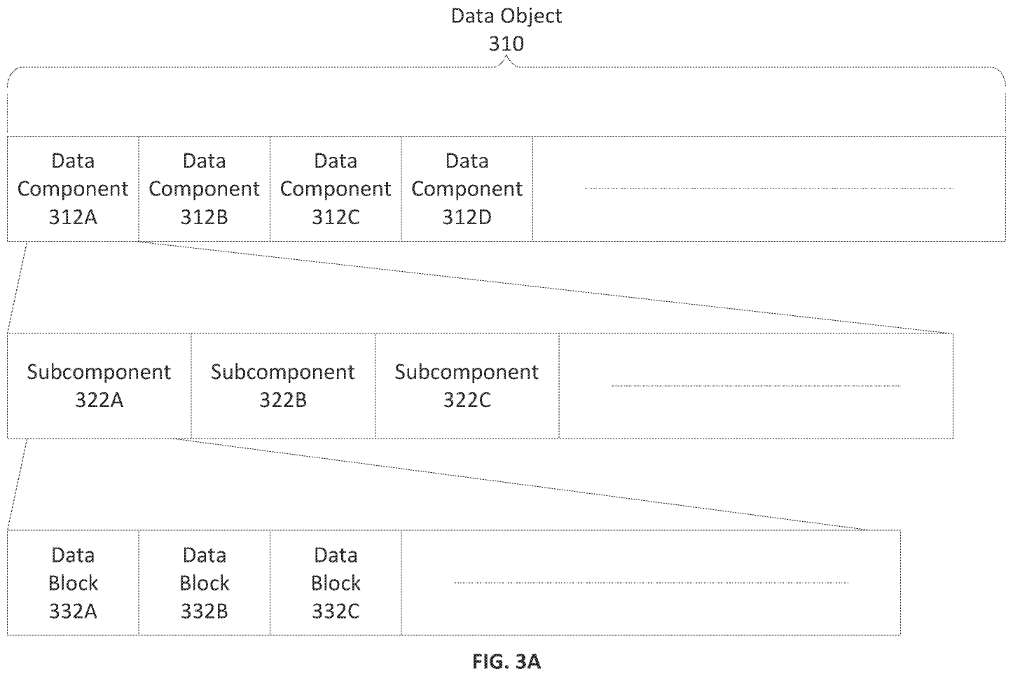

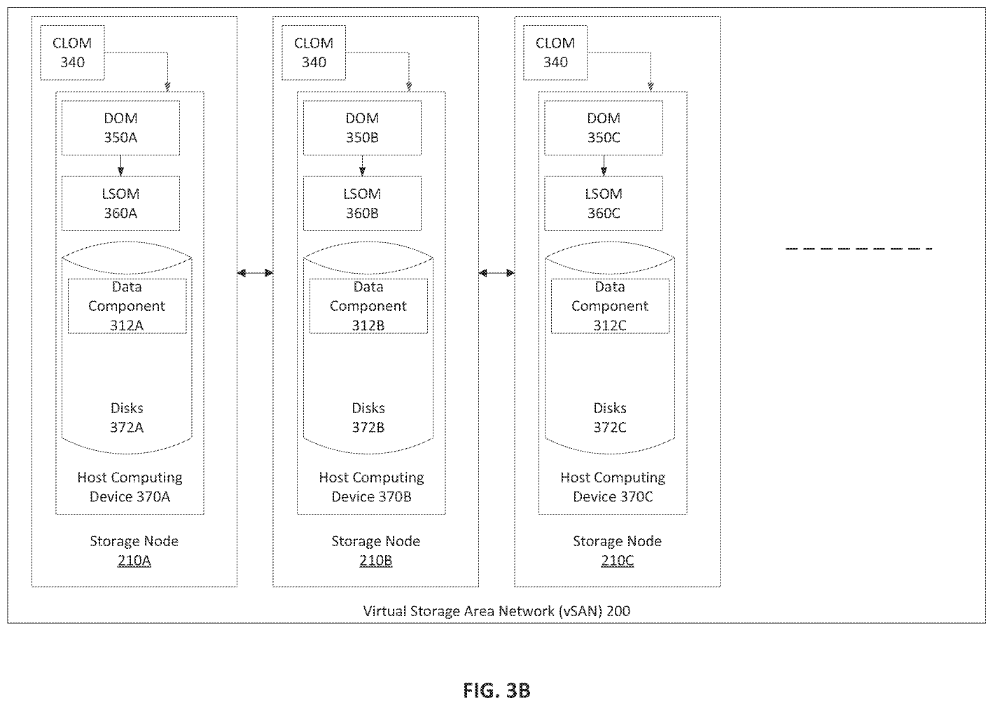

In a VSAN, one or more data components can be represented by a data object, which is managed by one or more object managers operating in VSAN. FIG. 3A is a block diagram illustrating the structure of a data object 310 that represents one or more data components, in accordance with some embodiments. Data object 310 can be a VSAN object managed by an object manager, such as a DOM owner managing one or more aspects of (and optionally, operating in) a storage node. The object manager that manages a data object is described in more detail below. In some embodiments, data object 310 can be stored at an address space, such as a space allocated in a virtual disk or a virtual storage pool. As described above, a virtual disk or a virtual storage pool corresponds to one or more physical disks of one or more storage nodes in a cluster of storage nodes. Thus, data components represented by data object 310 (e.g., an address space) can be stored in a distributed manner in one or more storage nodes in the cluster of storage nodes.

As illustrated in FIG. 3A, in some embodiments, data represented by data object 310 can be divided to and stored as one or more data components 312A, 312B, 312C, 312D, and so forth (collectively as data components 312). Each data component can represent data that are logically stored together (e.g., a file, a group of files, data that belongs to a same user, etc.). Moreover, data components can have same or different data sizes. As an example, all data components 312 can have a data size of about 128 Gb, although any data size is contemplated.

In some embodiments, a data component can be further divided to and stored as one or more subcomponents. For example, with reference to FIG. 3A, data component 312A can be divided to and stored as subcomponents 322A, 322B, 322C, and so forth (collectively as subcomponents 322). Each subcomponent can have a data size that is less than the data size of its corresponding data component. For example, data component 312A may have a data size of 256 Gb and each of subcomponents 322 may have a data size of 4 Mb. As described below, based on the dynamic partitioning techniques, dividing data of a data component to smaller subcomponents enables the distribution of data in a large data component to multiple storage nodes, while still complying with a data storage policy (e.g., a fault tolerance policy) for each subcomponent. As a result, read/write operation of the data in the large data component can be distributed to multiple storage nodes instead of a single storage node. Thus, the dynamic partitioning techniques that store subcomponents in multiple storage nodes enhance load balancing among storage nodes, while still complying with the data storage policy. As further described below, using subcomponents that have a smaller data size also facilitates a more effective redistribution of data from one storage node to another based on data structures (e.g., hash maps) of the subcomponents.

With reference to FIG. 3A, in some embodiments, each subcomponent can be further divided to and stored as multiple data blocks. For example, subcomponent 322A can be divided to and stored as data blocks 332A, 332B, 332C, and so forth (collectively as data blocks 332). Each data block can have a data size that is less than the data size of its corresponding subcomponent. For example, subcomponent 322A can have a data size of 4 Mb and each of data blocks 332 can have a data size of 4 Kb. As further described below, in some embodiments, a hash entry is generated for each data block and a hash map containing multiple hash entries is generated for each subcomponent. The hash map can be multi-casted to a plurality of target storage nodes for a more effective redistribution of data from one storage node to another. While the exemplary subcomponent and data block used in this application have data sizes of 4 Mb and 4 Kb, respectively, it should be appreciated that the subcomponents and the data blocks can have any desired data sizes.

FIG. 3B is a block diagram illustrating a VSAN 200 storing one or more data components in different storage nodes, in accordance with some embodiments. As described above, a data object can be stored at an address space representing multiple data components (e.g., data components 312A-C). For example, as illustrated in FIGS. 3A and 3B, data represented by a data object 310 can be divided to and stored as a plurality of data components including data components 312A-C. Each of data components 312A-C can have the same or different data size (e.g., a data size of 128 Gb).

In some embodiments, as illustrated in FIG. 3B, a plurality of data components represented by a data object can be stored in a plurality of storage nodes according to a pre-configured data storage policy. For example, as illustrated in FIG. 3B, in some embodiments, VSAN 200 can include a cluster of storage nodes including, for example, storage nodes 210A-C. As described above, storage nodes 210A-C can include host computing devices 370A-C, respectively. Host computing devices 370A-C can be implemented the same as or similar to host computing device 100 described above (e.g., implemented using ESXi hosts).

With reference to FIG. 3B, in some embodiments, VSAN 200 can include one or more cluster-level object managers (CLOMs), one or more distributed object managers (DOMs), and one or more local log structured object managers (LSOMs). These object managers can be processes generated by software components for managing a virtual storage area network such as VSAN 200. As illustrated in FIG. 3B, in some embodiments, a cluster-level object manager (CLOM) can be a process instantiated for managing data objects (e.g., providing data placement configurations for data object placements, resynchronization, rebalancing) for all storage nodes in a particular cluster of storage nodes. For example, a CLOM 340 can be instantiated at storage node 210A (e.g., instantiated in the hypervisor of host computing device 370A) of a cluster to manage data objects for all storage nodes in the cluster, which may include storage nodes 210A-C. Likewise, CLOM 340 can be instantiated at storage nodes 210B or 210C to manage data object for all storage nodes of the cluster of storage nodes. In some embodiments as shown in FIG. 3B, if storage nodes 210A-210C are nodes of a same cluster, one instance of CLOM 340 may be instantiated to manage all the storage nodes of the same cluster.

As described above, a data object can be stored at address spaces representing multiple data components (e.g., data components 312A-C may be represented by a data object). In some embodiments, as illustrated in FIG. 3B, CLOM 340 determines that multiple data components represented by a data object are to be stored in different storage nodes based on data storage policies and/or storage nodes capabilities. Based on such a determination, CLOM 340 can instruct one or more DOMs 350A-C to perform the operation with respect to the data components represented by the data object. A DOM can be a process instantiated at a particular storage node for managing data objects (e.g., processing Input/Output or I/O requests or synchronization requests) associated with that particular storage node. In some examples, one instance of a DOM can be instantiated in each storage node. A DOM instance can operate in, for example, a kernel space or a hypervisor of host computing device of a storage node. Multiple DOM instances operating in different storage nodes can also communicate with one another. As shown in FIG. 3B, DOMs 350A-C are instantiated and operate in storage nodes 210A-C, respectively, for managing the data objects representing data components stored on the corresponding nodes. In some embodiments, to perform operations for managing data objects, each of DOMs 350A-C can receive instructions from CLOM 340 and other DOMs operating in other storage nodes of a cluster. For example, for data resynchronization or rebalancing, CLOM 340 can generate new or updated data placement configurations. CLOM 340 can provide the new or updated data placement configurations to one or more of DOMs 350A-C. Based on the new or updated data placement configurations, one or more of DOMs 350A-C can perform a data resynchronization operation and/or a data rebalancing operation. In some embodiments, a DOM 350 can perform operations for managing data objects without receiving instructions from CLOM 340. For example, if data component 312A is not in compliance with the data storage policy for less than a predetermined period of time (e.g., data component 312A is offline momentarily), DOM 350A can perform a data resynchronization operation with respect to data component 312A without receiving instructions from CLOM 340.

In some embodiments, each storage node can have one or more DOM owners and one or more DOM clients. DOM owners and DOM clients are instances of a DOM. Each data object can be associated with one DOM owner and one or more DOM clients. In some embodiments, operations with respect to a data object are performed by a DOM. Thus, a data object is sometimes also referred to as a DOM object. A DOM owner associated with a particular data object receives and processes all I/O requests with respect to the particular data object. A DOM owner can perform the I/O operations with respect to the particular data object according to I/O operation requests received from a DOM client for the particular data object. For example, as shown in FIGS. 3A and 3B, data components 312A-C can be components represented by a same data object 310. DOM 350A can be the DOM owner of data object 310. An I/O operation request with respect to data component 312A may be received at a DOM client from an I/O component of a virtual machine. The I/O operation request may be forwarded from the DOM client to DOM 350A (the DOM owner of data component 312A). DOM 350A can further provide the I/O operation request to a DOM component manager to process the request to perform the I/O operation with respect to data component 312A stored in storage node 210A (e.g., processes the request and instructs LSOM 360A to perform the I/O operation with respect to data component 312A). In some embodiments, if I/O operations are performed with respect to a particular data component, other data components (e.g., duplicates of particular data component) can be synchronized with respect to the data alterations caused by the I/O operations.

FIG. 3B further illustrates one or more local log structured object managers (LSOMs) 360A-C. An LSOM can be a process instantiated at a particular storage node for performing data operations with respect to the data components stored on a particular storage node. As described above, a DOM can obtain instructions, requests, and/or policies from a CLOM and perform operations with respect to data objects, which are address spaces representing data components (e.g., data components 312A-C) of physical data. An LSOM performs operations with respect to these data components of physical data. Thus, data components (and their subcomponents) of a particular storage node are managed by the LSOM operating in the particular storage node.

In some examples, one instance of an LSOM can be instantiated in each storage node. An LSOM instance can operate in, for example, a kernel space or a hypervisor of host computing device of the storage node. As illustrated in FIG. 3B, for example, LSOM 360A-C are instantiated at storage nodes 210A-C, respectively, to perform data operations with respect to data components 312A-C respectively. For example, LSOM 360A-C can provide read and write buffering, data encryption, I/O operations with respect to the respective data components or subcomponents, or the like.

As described above with reference to FIG. 3B, in some embodiments, an entire data component can be stored in a single storage node. For example, the entire data component 312A can be stored in storage node 210A; the entire data component 312B can be stored in storage node 210B; and the entire data component 312C can be stored in storage node 210C; and so forth. In some embodiments, in VSAN 200, dynamic partitioning techniques can be implemented such that a single data component can be distributed to multiple storage nodes while still complying with data storage policies associated with the data component

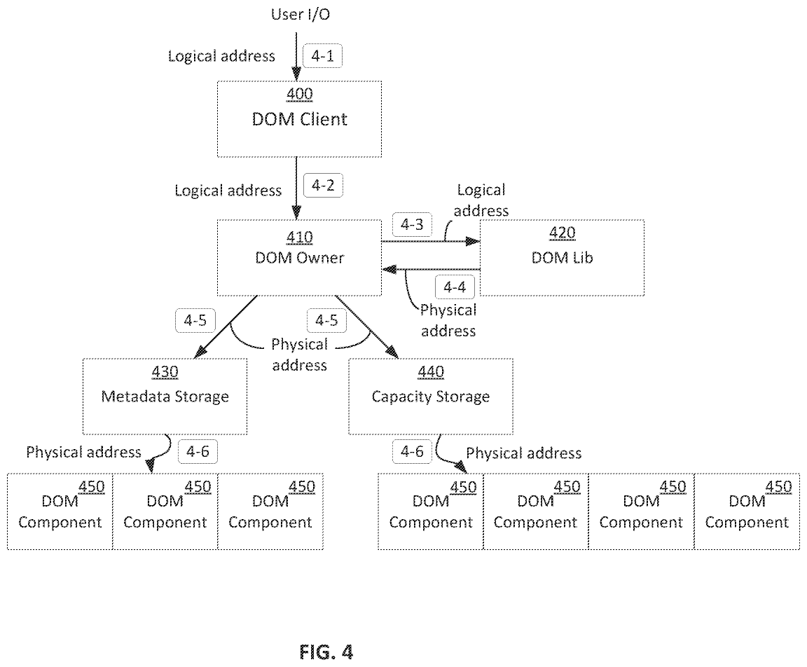

FIG. 4 is a block diagram representation of a process for inspecting and repairing VSAN object metadata. As above, VSAN metadata may be inspected and repaired via VSAN file repair methods. As an example, a user space tool or application-level program is used to request stored objects or their metadata from the DOMs (e.g., DOM 350x) in which they are stored. In conventional systems, the physical addresses of stored objects and their metadata are known only to the DOM. Accordingly, applications initiate read/write requests by transmitting a request which includes the logical address of the object or corresponding metadata to be read/written (Step 4-1). The logical address is transmitted to DOM client 400 of, e.g., a DOM 350x of FIG. 3B. The DOM client 400 selects the corresponding DOM owner 410 of the stored object, and forwards this logical address (Step 4-2). The DOM owner 410 then determines the corresponding physical address of the object in question, by consulting a DOM library 420 (Step 4-3). DOM library 420 may be an indirection layer or table, maintained by a particular DOM 350x and containing logical addresses of objects stored by a particular DOM, as well as their corresponding physical addresses. For each logical address submitted, DOM library 420 may thus return a corresponding physical address of a particular stored object or its metadata (Step 4-4).

The physical address may be one or both of a physical address of object data or metadata, according to the application request. DOM owner 410 may then transmit these physical addresses to a metadata storage section 430 and/or capacity storage section 440 as appropriate, for retrieval of the identified data (Step 4-5). Metadata storage section 430 and capacity storage section 440 are known processes for performing read/write operations to disk physical addresses. In read operations, the appropriate storage section 430, 440 reads and returns DOM component 450 data from the physical address it receives (Step 4-6). Returned data are returned back to the requesting application program. Similarly, in write operations (including writes of repaired metadata), storage sections 430, 440 receive data transmitted as part of the application request, and write it to the physical address received.

Accordingly, conventional application-level programs for conducting VSAN object metadata inspection and repair do not possess any knowledge of the physical addresses of any metadata sought to be repaired, instead relying on DOM internal libraries 420. In contrast, embodiments of the disclosure employ application-layer programs that maintain tables mapping object logical addresses to physical addresses at which object metadata are stored, allowing them to bypass internal DOM libraries 420 and send physical addresses at which reads/writes are to be conducted.

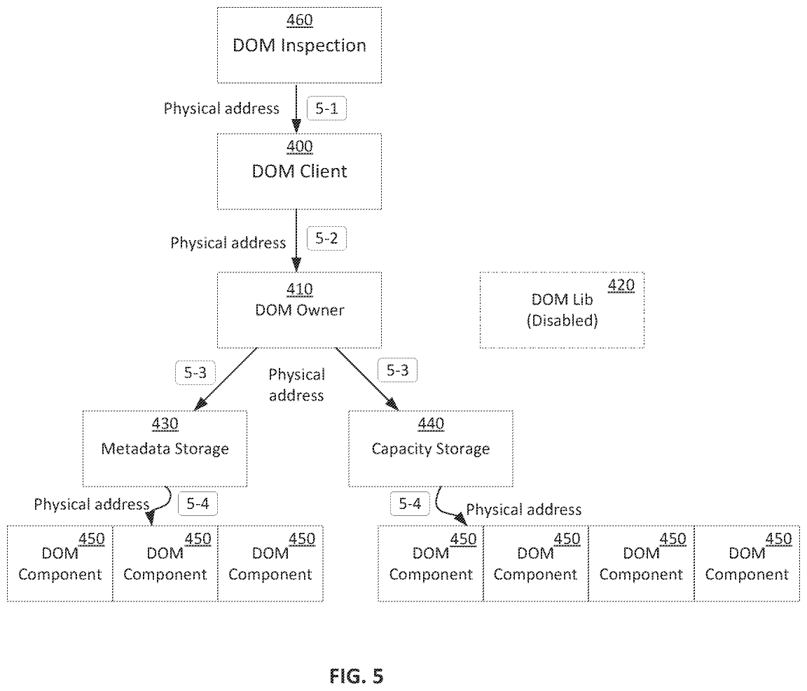

FIG. 5 is a block diagram representation of an exemplary process for inspecting and repairing VSAN object metadata, in accordance with some embodiments of the disclosure. Here, in contrast to conventional methods such as those shown in FIG. 4, an application-level program may initiate read/write requests by transmitting a physical address of the object metadata to be read/written (Step 5-1). More specifically, while conventional VSAN metadata repair applications do not possess knowledge of physical addresses of stored objects or their metadata, user space application programs of embodiments of the disclosure may maintain an application-level indirection layer, or table of object logical addresses and the physical or on-disk addresses of their object metadata, to map their knowledge of object logical addresses to corresponding physical addresses where their metadata are stored. In effect, application programs of embodiments of the disclosure may maintain a user-level or application-layer implementation of the DOM library 420 which is external to the VSAN. Read/write requests thus include the physical address of metadata the request seeks to inspect or repair.

DOM inspection program 460 may exemplify one such application program. In some embodiments of the disclosure, DOM inspection program 460 may be any application-layer program configured to transmit read and write commands to a VSAN. DOM inspection program 460 may initiate a VSAN object metadata inspection process by transmitting a request to a DOM client 400, where this request includes a physical address of the object metadata to be inspected. In some embodiments of the disclosure, DOM inspection program 460 may be configured as a VSAN client, although any configuration capable of exchanging commands and data with a VSAN is contemplated. Program 460 may further maintain its table of object physical addresses in a local memory or other accessible memory external to the corresponding VSAN. As above, this table may be maintained as a user-level or application-layer implementation of the DOM library 420 which is external to the VSAN. The implementation of DOM library 420 maintained locally by DOM inspection program 460 may be referred to as, e.g., a zDOM library, to avoid confusion with the DOM library 420 of the VSAN.

DOM client 400 passes this request, or the object physical address contained therein, to DOM owner 410 (Step 5-2). However, in contrast to the process of FIG. 4, DOM owner 410 now possesses the physical address at which the read/write operation is to be carried out, and thus does not need to retrieve any physical addresses from DOM library 420. In some embodiments of the disclosure, DOM library 420 is disabled by the DOM which receives the request of Step 5-1, or any component thereof. The DOM library 420 may be disabled in response to a user command or a command from DOM inspection program 460, or may be disabled automatically in response to reception of a read/write command containing a physical address instead of a logical address. In some embodiments, DOM client 400 or DOM owner 410 may disable DOM library 420 during the requested read/write operation, or may disable DOM library 420 until reception of a request to re-enable DOM library 420. As an example, the request to re-enable DOM library 420 may be received from DOM inspection application 460 after its metadata inspection and repair process is complete, and may be carried out by any DOM component including DOM client 400 or DOM owner 410.

DOM owner 410, having received the physical address at Step 5-2, may then execute the read/write operation by transmitting the address to metadata storage section 430 or capacity storage section 440 as appropriate (Step 5-3). In read operations, the appropriate storage section 430, 440 reads and returns DOM component 450 data from the physical address it receives (Step 5-4). Returned data are returned back to the DOM inspection program 460. Similarly, in write operations (including writes of repaired metadata), storage sections 430, 440 receive data transmitted as part of the application request, and write it to the physical address received.

While DOM inspection programs 460 of embodiments of the disclosure have been described as looking up and transmitting physical addresses of object metadata to associated DOMs, it may be observed that these programs 460 may also look up and transmit physical addresses of object data in similar manner. That is, embodiments of the disclosure encompass user space indirection layers which maintain physical addresses of both object data and associated object metadata. In this manner, I/O operations such as reads and writes may be conducted for both object data and object metadata.

After read operations, DOM inspection program 460 uses returned metadata or object data read from the transmitted physical address, to reconstruct data structures and/or content of object metadata. Thus, in some examples, DOM inspection program 460 reconstructs such structures and/or content in user space or DOM inspection application 460 memory. That is, the physical locations of VSAN object metadata are maintained at the application level, and used to retrieve and reconstruct stored object metadata, also at the application level. Metadata reconstruction may be performed in any manner. In some embodiments of the disclosure, DOM inspection applications 460 may reconstruct object metadata from retrieved metadata according to conventions by which the DOM may be known to generate metadata. In some embodiments of the disclosure, DOM inspection applications 460 may maintain a log of operations performed by the VSAN related to the metadata in question, and execute the operations in order to reconstruct a local copy of the metadata. The reconstructed state is then the object metadata representing the user's data stored in a state consistent to that which is stored in the VSAN. In some embodiments of the disclosure, DOM inspection applications 460 may be implemented as an interactive tool allowing users to manually conduct metadata repairs, such as manually inspecting and correcting metadata to restore such metadata back to a correct or consistent state. In some embodiments of the disclosure, DOM inspection applications 460 may determine multiple metadata repair candidate solutions which would each repair metadata inconsistencies, such as from retrieved objects and knowledge of rules by which the DOM generates metadata, and permit users to select from among these candidate solutions.

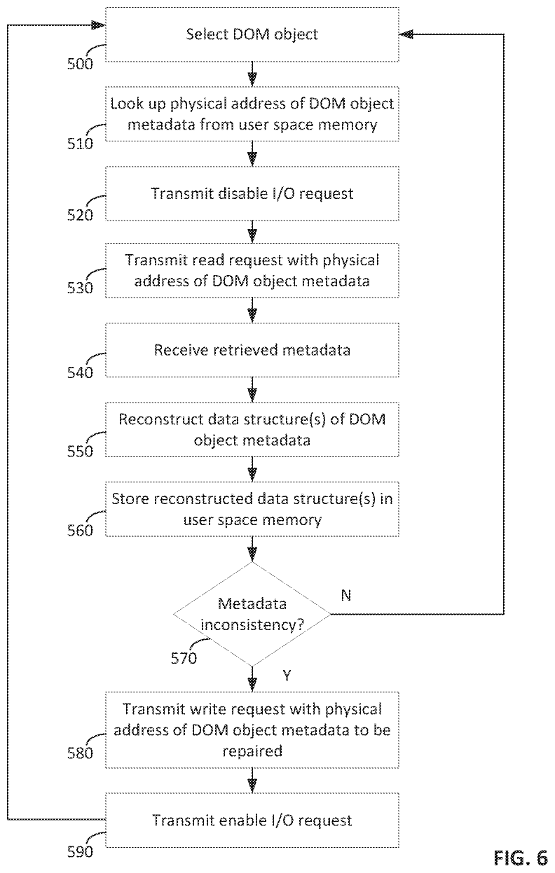

FIG. 6 is a flowchart illustrating process steps for inspecting and repairing VSAN object metadata, in accordance with some embodiments of the disclosure. Initially, a user space application such as DOM inspection application 460 may select a DOM object for inspection of its metadata (Step 500). As above, DOM inspection application 460 may maintain an accessible library identifying stored DOM objects and the physical addresses of their data and/or metadata. The DOM inspection application 460 may then look up the physical address of the selected DOM object metadata from its library (Step 510).

DOM inspection application 460 then initiates an inspection of the object's VSAN metadata. The DOM inspection application 460 transmits a disable I/O request to the DOM managing the object (Step 520). As above, this request instructs the DOM owner 410 to disable or disregard read/write requests which are not meant for metadata inspection and repair, e.g., those containing a logical address of a VSAN object, and allow only those read/write requests containing a physical address. In some embodiments of the disclosure, DOM owner 410 may disable its DOM library 420 in response. In some embodiments, the DOM owner 410 may be programmed to enter a specified disable I/O mode (disabling all I/O requests containing logical addresses but allowing I/O requests containing a physical address) upon receiving this request from the application 460, although any method of suspending I/O operations during metadata inspection and repair is contemplated. In some embodiments, this mode may be object-specific, disabling I/O operations containing logical addresses for a specified object only, and not for others. In some embodiments, the disable I/O mode may disable all I/O requests except for those containing a bypass flag set to allow such requests to be carried out. In such embodiments, application 460 may separately instruct DOM owner 410 to enter/exit disable I/O mode.

DOM inspection application 460 may then transmit a read request which includes the physical address of the DOM object metadata it is seeking to inspect (Step 530). As this request contains a physical address, the DOM owner 410 proceeds to retrieve the desired metadata according to Steps 5-3 and 5-4 as above, and return the retrieved metadata to the DOM inspection application 460 (Step 540). Object data may also be read and returned if the read request contains the object's physical address. In some embodiments of the disclosure, DOM owner 410 may be programmed to enter the disable I/O mode of Step 520 automatically upon receipt of a read request which includes a physical address. In such embodiments, Step 520 may not be required.

DOM inspection application 460 may then reconstruct the data structures and content of object metadata (Step 550). In some embodiments, metadata of multiple objects may be retrieved via repetition of Steps 500-540. Data structures may then be reconstructed from the retrieved metadata. As above, reconstruction may be performed in any desired manner. In some embodiments of the disclosure, DOM inspection applications 460 may reconstruct object metadata from the content of retrieved metadata and knowledge of rules by which the DOM generates metadata. As above, DOM inspection applications 460 may maintain a log of operations performed by the VSAN related to the metadata in question, and execute the operations in order to reconstruct a local copy of the metadata. The reconstructed state is then the object metadata representing the user's data stored in a state consistent to that which is stored in the VSAN. The reconstructed metadata may be stored in a user space memory, i.e., a memory accessible to DOM inspection application 460 (Step 560).

The reconstructed metadata is then traversed for inconsistencies (Step 570). In some embodiments of the disclosure, DOM inspection applications 460 may be implemented as an interactive tool allowing users to manually conduct metadata repairs such as manually inspecting reconstructed metadata to catch any inconsistencies or errors, and manually implementing repairs or corrections to bring the metadata back to a consistent state. In some embodiments of the disclosure, DOM inspection applications 460 may automatically scan reconstructed metadata for inconsistencies, determine one or more potential metadata fixes which would each repair metadata inconsistencies such as from retrieved objects and knowledge of rules by which the DOM generates metadata, and permit users to select from among these candidates. As an example, DOM inspection applications 460 may detect orphaned data nodes and may offer the user an option to discard the orphaned node. The DOM inspection applications 460 may further attempt to infer the parent node and offer the user an additional option to restore the parent-child relationship using the inferred parent, to select another parent if the inferred parent node is incorrectly identified, or the like.

If no inconsistency is found, the process may return to Step 500, to check metadata of other objects. An inconsistency may indicate a corruption or other error in the metadata of the VSAN. DOM inspection application 460 may then seek to correct or repair the reconstructed metadata by revising inconsistent or otherwise erroneous portions to resolve the inconsistency/error. Subsequently, DOM inspection application 460 may also implement this correction in the metadata of the VSAN. In particular, DOM inspection application 460 may transmit a write request with the physical address of the object metadata to be corrected (Step 580). As this write request contains a physical address, it bypasses the disable I/O mode of DOM owner 410, and is written at the specified physical address according to Steps 5-3 and 5-4 above. Metadata having been restored to a consistent state, DOM inspection application 460 may then transmit an enable I/O request to DOM owner 410 (Step 590), instructing it to exit its disable I/O mode and resume accepting and executing all I/O requests. The process may then terminate, or return to Step 500 for inspection and repair of further VSAN objects.

The metadata inspection and repair process exemplified in FIG. 6 may be carried out at any desired time. For example, object metadata may be inspected and repaired after specified events, such as VSAN kernel crashes, as part of the repair and recovery process therefor. Inspection and repair processes of embodiments of the disclosure may also be carried out as part of system testing or diagnostic operations, or may also be carried out periodically or at specified intervals.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings. One of ordinary skill in the art will also understand that various features of the embodiments may be mixed and matched with each other in any manner, to form further embodiments consistent with the disclosure.

What is claimed is:

1. A method of inspecting metadata of virtual storage area network (VSAN) objects, the method comprising:
transmitting, to a distributed object manager (DOM) client of the VSAN, a request to retrieve metadata of a DOM object, the request including a physical memory address of the metadata of the DOM object;
receiving, from the DOM client and responsive to the transmitted request, the retrieved metadata corresponding to the physical memory address;
determining, based at least in part on the retrieved metadata corresponding to the physical memory address, a data structure of the metadata of the DOM object; and
storing the determined data structure in a memory.

2. The method of claim 1, further comprising:
determining an inconsistency in the determined data structure;
revising a portion of the determined data structure to resolve the inconsistency; and
transmitting, to the DOM client, a request to write the revised portion of the determined data structure to the metadata of the DOM object.

3. The method of claim 2, further comprising:
prior to the transmitting the request to write the revised portion of the determined data structure to the metadata of the DOM object, transmitting, to the DOM client, a request to disregard data transfer requests including a logical memory address of a DOM object; and
after the transmitting the request to write the revised portion of the determined data structure to the metadata of the DOM object, transmitting, to the DOM client, a request to carry out the data transfer requests including a logical memory address of a DOM object.

4. The method of claim 2, wherein the request to write includes a physical memory address of the metadata of the DOM object, the request to write being a request to write the revised portion of the determined data structure to the metadata of the DOM object at the physical memory address.

5. The method of claim 1, further comprising:
prior to the transmitting the request to retrieve metadata of the DOM object, transmitting, to the DOM client, a request to disregard data transfer requests other than the request to retrieve metadata; and
after the transmitting the request to retrieve metadata of the DOM object, transmitting, to the DOM client, a request to carry out the data transfer requests other than the request to retrieve metadata.

6. The method of claim 1, wherein the transmitting further comprises transmitting the request from an application program configured as a client of the VSAN.

7. The method of claim 1, wherein the memory is a memory of the application program.

8. The method of claim 1, wherein the transmitting further comprises transmitting the request from a user space.

9. A non-transitory computer-readable storage medium storing instructions configured to be executed by one or more processors of a computing device, to cause the computing device to carry out steps that include:
transmitting, to a distributed object manager (DOM) client of the VSAN, a request to retrieve metadata of a DOM object, the request including a physical memory address of the metadata of the DOM object;
receiving, from the DOM client and responsive to the transmitted request, the retrieved metadata corresponding to the physical memory address;
determining, based at least in part on the retrieved metadata corresponding to the physical memory address, a data structure of the metadata of the DOM object; and
storing the determined data structure in a memory.

10. The non-transitory computer-readable storage medium of claim 9, wherein the instructions, when executed by the one or more processors of the computing device, further cause the computing device to carry out steps that include:
determining an inconsistency in the determined data structure;
revising a portion of the determined data structure to resolve the inconsistency; and
transmitting, to the DOM client, a request to write the revised portion of the determined data structure to the metadata of the DOM object.

11. The non-transitory computer-readable storage medium of claim 10, wherein the instructions, when executed by the one or more processors of the computing device, further cause the computing device to carry out steps that include:
prior to the transmitting the request to write the revised portion of the determined data structure to the metadata of the DOM object, transmitting, to the DOM client, a request to disregard data transfer requests including a logical memory address of a DOM object; and
after the transmitting the request to write the revised portion of the determined data structure to the metadata of the DOM object, transmitting, to the DOM client, a request to carry out the data transfer requests including a logical memory address of a DOM object.

12. The non-transitory computer-readable storage medium of claim 10, wherein the request to write includes a physical memory address of the metadata of the DOM object, the request to write being a request to write the revised portion of the determined data structure to the metadata of the DOM object at the physical memory address.

13. The non-transitory computer-readable storage medium of claim 9, wherein the instructions, when executed by the one or more processors of the computing device, further cause the computing device to carry out steps that include:
prior to the transmitting the request to retrieve metadata of the DOM object, transmitting, to the DOM client, a request to disregard data transfer requests other than the request to retrieve metadata; and
after the transmitting the request to retrieve metadata of the DOM object, transmitting, to the DOM client, a request to carry out the data transfer requests other than the request to retrieve metadata.

14. The non-transitory computer-readable storage medium of claim 9, wherein the transmitting further comprises transmitting the request from an application program configured as a client of the VSAN.

15. The non-transitory computer-readable storage medium of claim 9, wherein the memory is a memory of the application program.

16. The non-transitory computer-readable storage medium of claim 9, wherein the transmitting further comprises transmitting the request from a user space.

17. A computer system, comprising:
one or more processors; and
memory storing one or more programs configured to be executed by the one or more processors, the one or more programs including instructions for:
transmitting, to a distributed object manager (DOM) client of the VSAN, a request to retrieve metadata of a DOM object, the request including a physical memory address of the metadata of the DOM object;
receiving, from the DOM client and responsive to the transmitted request, the retrieved metadata corresponding to the physical memory address;
determining, based at least in part on the retrieved metadata corresponding to the physical memory address, a data structure of the metadata of the DOM object; and
storing the determined data structure in a memory.

18. The computer system of claim 17, wherein the one or more programs include further instructions for:
determining an inconsistency in the determined data structure;
revising a portion of the determined data structure to resolve the inconsistency; and
transmitting, to the DOM client, a request to write the revised portion of the determined data structure to the metadata of the DOM object.

19. The computer system of claim 18, wherein the request to write includes a physical memory address of the metadata of the DOM object, the request to write being a request to write the revised portion of the determined data structure to the metadata of the DOM object at the physical memory address.

20. The computer system of claim 17, wherein the one or more programs include further instructions for:
prior to the transmitting the request to retrieve metadata of the DOM object, transmitting, to the DOM client, a request to disregard data transfer requests other than the request to retrieve metadata; and
after the transmitting the request to retrieve metadata of the DOM object, transmitting, to the DOM client, a request to carry out the data transfer requests other than the request to retrieve metadata.
